(19) United States
(12) Patent Application Publication
(10) Pub. No.: US 2015/0051782 A1
(43) Pub. Date: Feb. 19, 2015

(54) Automatic Driverless Motor Vehicle Driving and Guidance System

(71) Applicant: Wayne Anthony Sutherland, Miami, FL (US)

(72) Inventor: Wayne Anthony Sutherland, Miami, FL (US)

(21) Appl. No.: 13/970,567

(22) Filed: Aug. 19, 2013

(51) Int. Cl. G05D 1/02

(52) U.S. Cl. CPC G05D 1/0212
USPC 701/25

(57) ABSTRACT

An automatic motor vehicle driving and guidance system that does not require the intervention of a human driver while the vehicle is in motion along a roadway that is equipped with this invention of an Automatic Driverless Motor Vehicle Driving and Guidance System. This invention can reduce motor vehicle accidents that occur due to driver fatigue or distraction. The system can regulate the speed of the motor vehicle, maintain the moving vehicle within the travel lane, monitor and regulate the safe traveling distance to vehicles travelling of stopped ahead, give the real time location of the motor vehicle and can be used to preprogram trips or routes

### BACKGROUND

Motor vehicle accidents on highways frequently occur when the vehicle encroach into adjacent travel lanes or onto shoulders or into vehicle or objects ahead. Visual aids such and lane markers, light reflectors and grooves are embedded in the roadway pavement to assist drivers in staying within lanes.

The problem is that drivers are not always alert due to fatigue or distractions; therefore a system is needed to assist drivers to safely maintain the vehicle traveling within the travel lane and at a safe distance from any vehicle or objects ahead and at safe travel speeds specified by the transportation authorities.

### BRIEF SUMMARY OF THE INVENTION

The objective of this invention is to provide a system that will maintain any motor vehicle traveling within the travel lane at a prescribed distance from both the left and right edges of the travel lane and at a prescribed speed and at a prescribed safe travel distance from any moving vehicle traveling ahead that will also stop the vehicle at a safe distance from a stopped vehicle or object ahead.

### BRIEF DESCRIPTION OF THE DRAWINGS

FIG. 1 shows a motor vehicle, the travel lane, distances from both the left and right edges of the travel lane, signal receiver, transmitters, reflectors, system disconnect switch and speed control.

FIG. 1A is a flow chart of how the system works if the system shown in FIG. 1 is installed

FIG. 2 shows a motor vehicle, the travel lane, distances from both the left and right edges of the travel lane, signal receiver, transmitters, reflectors, system disconnect switch and speed control.

FIG. 2A is a flow chart of how the system works if the system shown in FIG. 2 is installed

FIG. 3 is a flow chart for the detection of vehicles or object ahead.

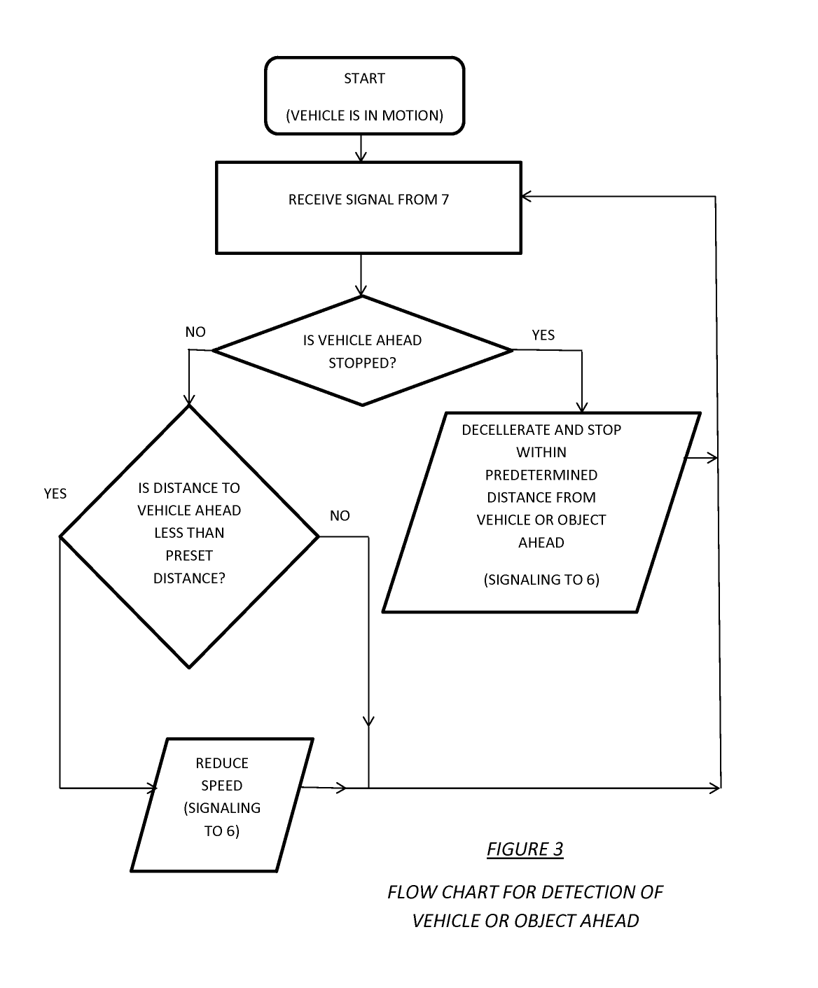

### DETAILED DESCRIPTION AND OF THE INVENTION

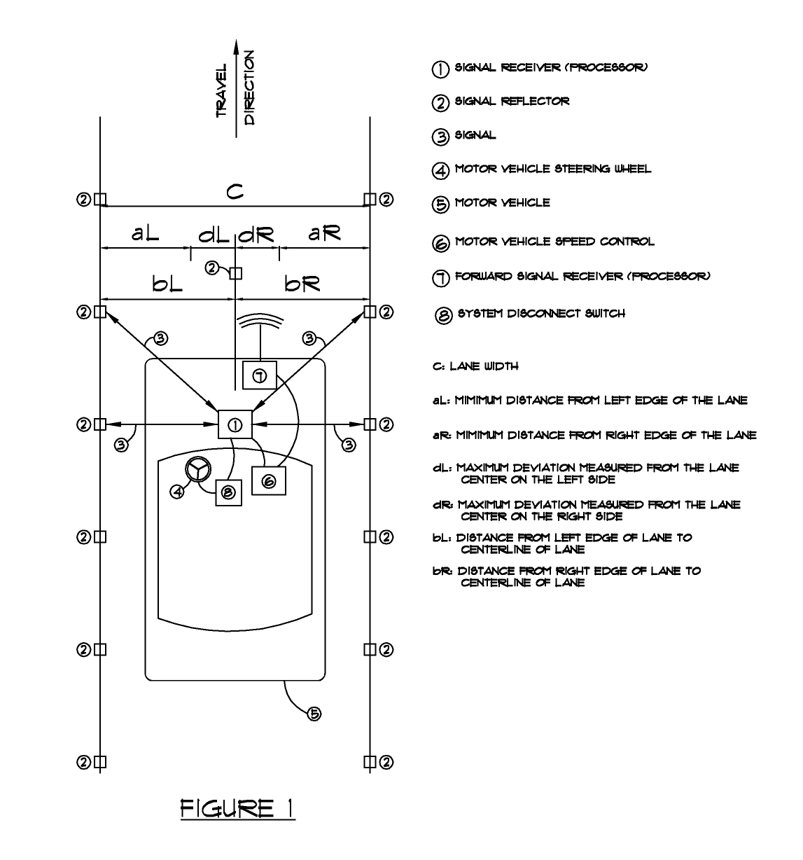

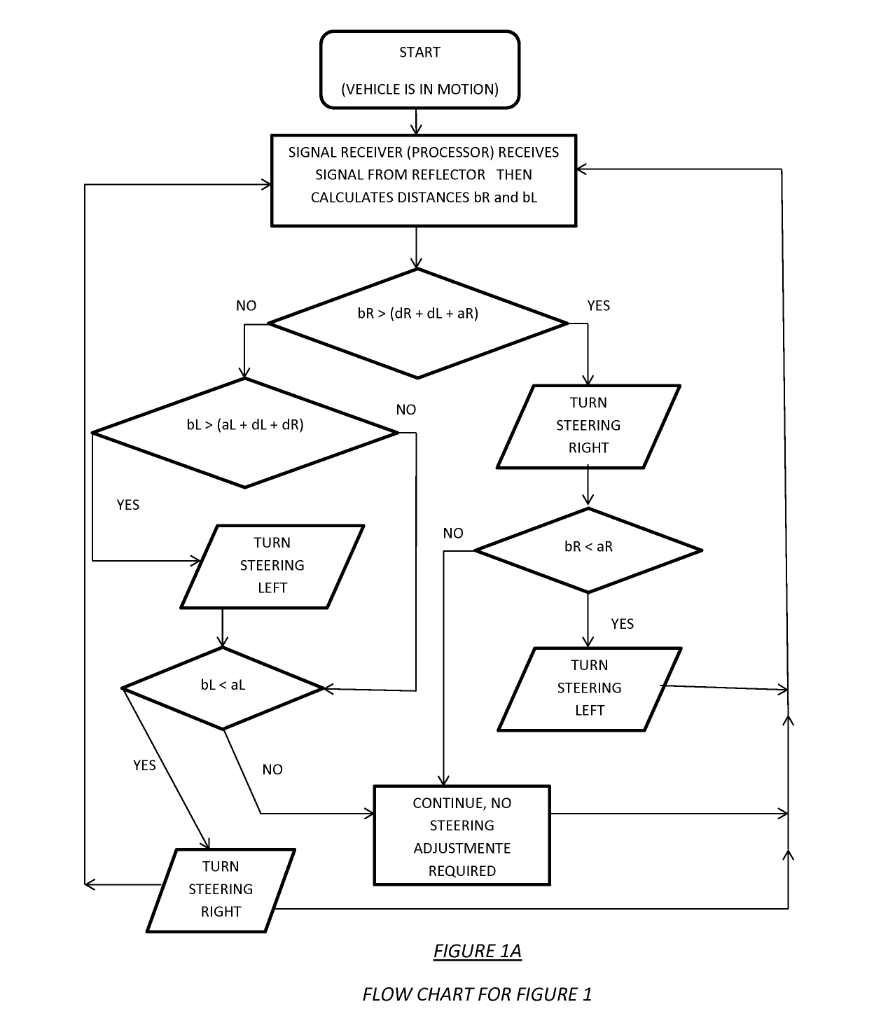

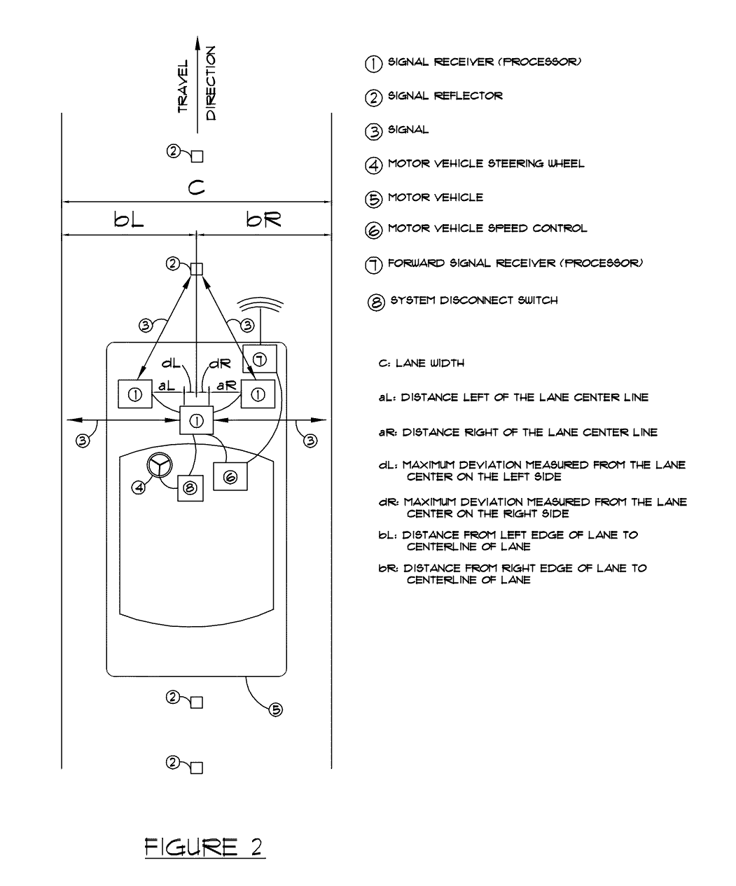

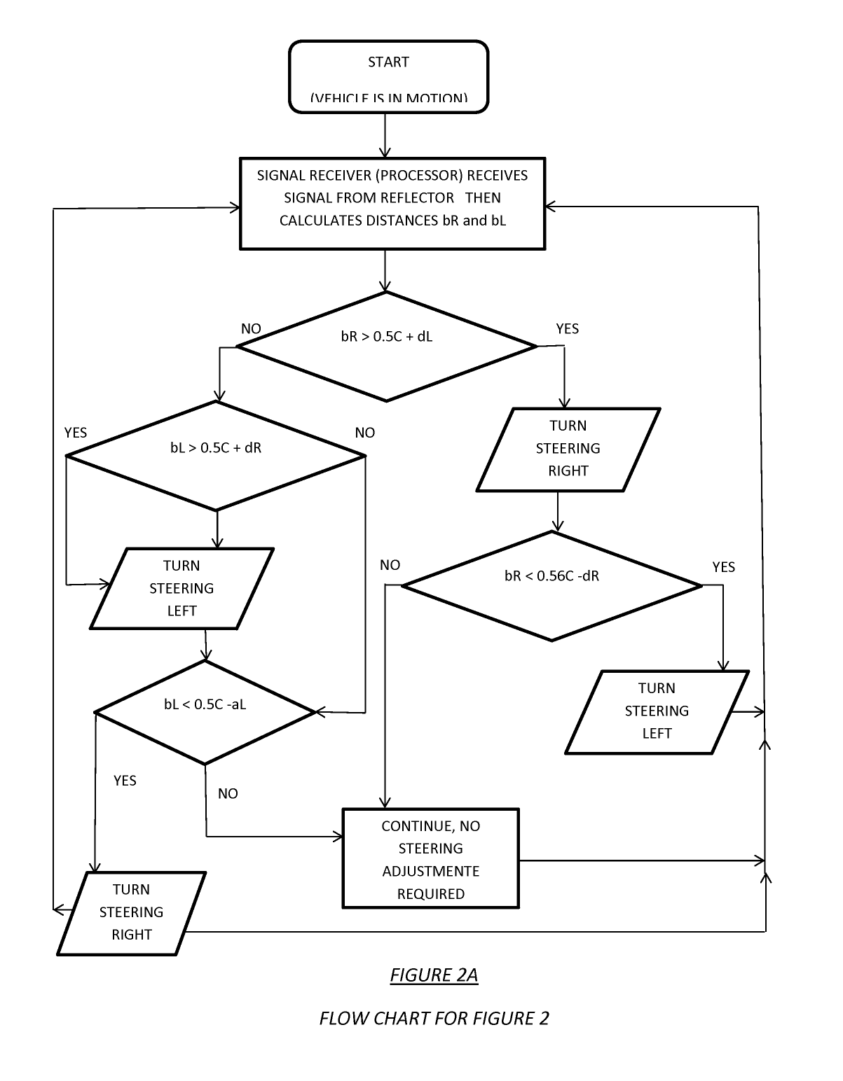

The Automatic Driverless Motor Vehicle Driving and Guidance System. shown in FIG. 1 and FIG. 2, comprise the following parts; (part numbers are shown in FIG. 1 and FIG. 2); part 1 is a Signal Receiver that sends signals via sound waves, light, radio waves, laser or other types of signal that process and calculate distances based on the reflection of the signal (part 3) off the Signal Reflector (part 2) back to itself while the vehicle is in motion or while the vehicle is not moving. The function of the Signal Reflector (part 2) is to reflect (return) the signal received from the signal receiver. The Signal Reflector is any material that can reflect the signal sent by the Signal Receiver (processor) and is durable enough to withstand traffic wheel loads and the elements. The Signal Reflector can be fixed within the roadway pavement either along the outer edges of the driving lane, as shown in FIG. 1 or along the center line of the driving lane as shown in FIG. 2. The Signal Reflector can be configured to reflect a unique identity code that includes its location which in turn can be used to guide a vehicle to a preprogrammed location or destination and can identify the real time location of the vehicle. The unique code of the Signal Reflector includes the minimum and maximum speed at which the motor vehicle is allowed to travel at the location of the Signal Reflector. This speed can be incorporated in the cruise control system of the motor vehicle. Part 3 is the signal, sound waves, light, radio waves, laser or other types of signal. The Motor Vehicle Steering Wheel (part 4), is the motor vehicle steering device. The Motor Vehicle, (part 5), is any car, truck, bus, bikes or other vehicle that use the roadway. The Motor Vehicle Speed Control (part 6), is the device that regulates the speed of the subject vehicle, it receives input from the Signal Processor (part 1) and the Forward Receiver (part 7). The Forward Signal Receiver (processor) (part 7) sends a signal via sound waves, light, radio waves, laser (or other types of signal) ahead of the vehicle to detect the presence of any vehicle or objects ahead. The Forward Signal Receiver (processor) process the distance and speed of the vehicle ahead, calculates the speed required to maintain a specified safe travel distance between the subject vehicle and the vehicle or object ahead and sends the calculated required speed to the Motor Vehicle Speed Control to adjust the speed. If the vehicle or object ahead is not moving a signal to stop is sent to the Motor Vehicle Speed Control. System Disconnect Switch (part 8), is used to switch from the Automatic driving system to manual so that the driver can take over and drive the vehicle.

A flowchart of the operation of the system is shown in FIG. 1A and FIG. 2A

Distances, aL, aR, dL, dR, bL, bR shown in FIG. 1 and FIG. 2 are predetermined and based on the lane width (C), bL and bR are minimum travelling distances from the left and right edges of the travel lanes

I claim

1. An automatic motor vehicle driverless driving and guidance system that does not require the intervention on a driver while the vehicle is moving along a road way where this system is installed. The system can regulate the speed of the motor vehicle, maintain the moving vehicle within the travel lane, monitor and regulate the safe traveling distance to vehicles travelling of stopped ahead, give the real time location of the motor vehicle and can be used to preprogram trips or routes.
